(19) United States
(12) Patent Application Publication
(10) Pub. No.: US 2017/0289504 A1
(43) Pub. Date: Oct. 5, 2017

(54) Privacy Supporting Computer Vision Systems, Methods, Apparatuses and Associated Computer Executable Code

(71) Applicant: ANTS TECHNOLOGY (HK) LIMITED., Wanchai (HK)

(72) Inventors: Ron Fridental, Shoham (IL); Ilya Blayvas, Jerusalem (IL); Gal Perets, Mazkeret Batya (IL)

(21) Appl. No.: 15/086,083

(22) Filed: Mar. 31, 2016

(51) Int. Cl. H04N 7/18; G06K 9/00

(52) U.S. Cl. CPC H04N 7/181; G06K 9/00765; G06K 9/00771; G06K 2009/00738

(57) ABSTRACT

According to some embodiments of the present invention there may be provided one or more video surveillance units including: (i) video capturing equipment (e.g. a video camera), (ii) processing circuitry adapted to modify/sanitize video streams captured by the video capturing equipment to generate sanitized video streams devoid of privacy infringing data/images, and (iii) communication circuitry for transmitting sanitized video streams to one or more monitoring units for analysis. The monitoring units, in turn, may analyze the sanitized video streams to identify security events occurring within the area being captured by the surveillance units.

### FIELD OF THE INVENTION

The present invention is generally related to the field of video surveillance. More specifically, the present invention is related to the field of privacy supporting computer vision systems.

### BACKGROUND

Advances in digital imaging technology, computing power and computer vision methods had led to the widespread use of computer vision systems, which tackle an ever-growing list of applications.

One of the applications of computer vision system is video surveillance, where the challenge is to automatically detect emergency situations. Emergency situations may include fire, violence, crime, medical emergencies and others. Therefore widespread installation of the computer vision systems for automatic surveillance can dramatically benefit society.

There are many places, however, where installation of surveillance cameras would compromise personal privacy. Restrooms, bathrooms, swimming pools, private houses are but a few examples of such places.

Moreover, privacy protection provided by the video system may not provide satisfying privacy protection, since the video captured by the camera may be leaked due to mistakes or malicious security attacks (“hacks”).

Therefore there is a growing need for video systems which, on one hand, will provide functionality of computer vision systems and, on the other hand, will protect the privacy of the imaged individuals.

In this disclosure we describe methods and systems enabling computer vision automatic surveillance solutions, while protecting user privacy.

### SUMMARY OF THE INVENTION

The present invention includes privacy supporting computer vision systems, methods, apparatuses and associated computer executable code.

Computer vision system can be defined as a system for (A1) acquisition of video data from certain scene by one or more video cameras, further (A2) automatic analysis of the acquired data, and (A3) relaying of the results of the said analysis for further use by the system.

Significant flexibility need to be secured in the above definition in order to span the definition over the wide domain of various possible computer vision systems: (A1) The video data can be acquired in the visible, UV or infra-red domains of electromagnetic spectrum, by monochrome, color or multi-band sensors, mono or stereo cameras, along with other sensory data, such as audio, 3D or others.

The goal of the (A2) automatic analysis of the acquired video can be monitoring, recognition and tracking of certain people and/or objects; detection of certain situations and extraction of the certain data, etc. The range of the problems tackled by computer vision can be at least as wide as the tasks which can be delegated to a human observer of the same acquired video stream.

As for (A3) relaying of the results of the said analysis for further use by the system, the ‘further use’ can vary widely, according to the vast range of possible applications. It can be alarming of people or systems, video recording of certain specific situations, quantitative analysis etc.

Privacy violation can be defined as the leak of certain information towards the certain human observers. Therefore a privacy threat is the risk of the leak of certain information towards the access of unauthorized users. The level of the information that is perceived as a privacy violation may differ significantly among the users and the situations. For some people the mere information at what hour they return home may be perceived as a privacy violation, while other people may enjoy streaming the video from their private bedrooms to open internet access.

Therefore, the method/apparatus enabling privacy for computer vision system should prevent the leakage of compromising information while still enabling the functionality of the computer vision system.

Large amount of possible computer vision systems and applications, as well as the wide definition of user privacy make it impossible to explicitly describe the optimal solutions for each specific case. However, it is the goal of the present disclosure to describe the systems and methods which modifications span the exhaustive set of solutions supporting user privacy in the specific embodiments of computer vision systems.

In a simplified view a computer vision system consists of: a video camera component/subsystem acquiring video/images, a processing component/subsystem extracting data from the video/images for the computer vision information, from the video, and a transmission component/subsystem, transmitting the results and/or video to a remote computer, for further storage, processing, or further transmission. Privacy can be compromised if sensitive contents reach a point from which they can be further transmitted, copied and/or stored and accessed.

One disclosed way of privacy support in computer vision systems is integration of the video camera and computer vision module, and complete isolation of the acquired video from further transmission, so that only the results and signal derived in the computer vision module are made available to the transmission component/subsystem, for further processing or transmission.

Another disclosed way of privacy support in computer vision systems is processing of the acquired video within the camera and nullifying/removal/modification of privacy compromising information, before further processing and transmission. What information is erased, removed, overwritten or modified may be defined according to the relevant definition of privacy. In one embodiment faces of the participants may be detected and blurred out. In other embodiment the areas of naked skin may be obscured or erased. In another embodiment all the information disclosing peoples identity may be erased. In another embodiment all the humans and their motion may be erased. In yet another embodiment all the acquired video is processed, and only certain computer vision descriptors, required for further processing, such as features extracted for classification, motion flow, results of segmentation, detected edges etc. are extracted from the video and made available to the transmission component/subsystem, for further processing or transmission.

According to some embodiments of the present invention there may be provided one or more video surveillance units including: (i) video capturing equipment (e.g. a video camera), (ii) processing circuitry adapted to modify/sanitize video streams captured by the video capturing equipment to generate sanitized video streams devoid of privacy infringing data/images, and (iii) communication circuitry for transmitting sanitized video streams to one or more monitoring units for analysis. The monitoring units, in turn, may analyze the sanitized video streams to identify security events occurring within the area being captured by the surveillance units.

According to some embodiments, sanitizing/modifying a video stream to protect privacy may include extracting specific parameters of the video data, which parameters have been found to indicate emergency situations. The sanitized video stream may then be comprised of the extracted parameters, without the other video data, thereby allowing the monitoring units to identify emergency situations occurring (based on the extracted parameters) without sending the complete video stream to the monitoring device, such that privacy is not compromised if the stream is intercepted or accidently falls into the wrong hands.

Alternatively, or in combination, a process of removing privacy sensitive data from the captured video stream may be performed to generate a sanitized video stream. For example, faces of individuals in the video stream may be identified and removed or blurred to prevent their identification. Similarly, a particular area of the video stream, where a private matter is filmed, may be removed or blurred. For example, image data from an area surrounding a toilet may be removed from the video stream.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A: is a schematic drawing of the prior art computer vision systems;

FIG. 1B: is a schematic drawing of a privacy supporting computer vision system, according to some embodiments of the present invention;

FIG. 1C: is a schematic drawing of a privacy supporting computer vision system, according to some embodiments of the present invention;

FIG. 1D: is a schematic drawing of an exemplary computer vision system, according to some embodiments of the present invention;

FIG. 2: is a schematic illustration of the architecture of computer vision system according to some embodiments of the present invention;

FIG. 3: is a block diagram illustrating an exemplary privacy protecting automated video surveillance system, according to some embodiments of the present invention.

FIG. 4: is a flow chart illustrating exemplary steps of operation of an exemplary video surveillance system, according to some embodiments of the present invention; and

FIG. 5: is a schematic illustration of the architecture of neural network computer vision system according to some embodiments of the present invention;

It will be appreciated that for simplicity and clarity of illustration, elements shown in the figures have not necessarily been drawn to scale. For example, the dimensions of some of the elements may be exaggerated relative to other elements for clarity.

It should be understood that the accompanying drawings are presented solely to elucidate the following detailed description, are therefore, exemplary in nature and do not include all the possible permutations of the present invention.

### DETAILED DESCRIPTION

Progress in the computational power available in the computing systems at all levels—from embedded devices to the servers on the cloud as well as the advances in the computer vision and deep learning algorithms paved the road for implementation of computer vision systems in many domains of human activity.

Rapid spreading of computer vision solutions systems results in pervasive and ever growing number of installed video cameras. New and emerging systems require installation of the cameras in the privacy sensitive areas, such as private houses, swimming pools, change rooms, bathrooms etc.

This progress leads to the certain contradictions: On one hand the new computer vision solutions and systems help saving lives and making the life easier, on the other hand widespread installation of video cameras in the ever growing number of places and location types rises the concern for potential compromising of the privacy of the people surveyed by those cameras.

It is important to observe that it is not the fact that a camera surveys a person/scene that violates privacy, rather the fact that the acquired video or information will reach or may be accessed by others.

Therefore, a privacy supporting computer vision system according to embodiments of the present invention should mitigate or prevent the possibility of the misappropriation of privacy violating video, images and/or information, while maintaining the functionality of computer vision systems.

It is important to observe that the definition of privacy may vary depending upon many factors, including the individuals in question, the circumstances, the location and its public/private nature, the jurisdiction and so on. Some persons may enjoy streaming their life and sex affairs for public access into the internet, for some other persons the mere publication of the fact that they were at a certain place at a certain time is considered a privacy violation.

The information deduced by computer vision systems from acquired video may vary, depending on the goals for which the computer vision system was designed and programmed. In many cases the deduced information does not contain any privacy compromising information.

Consider as a first example: a computer vision system surveying a bathroom and providing an alarm in a case of a child drowning in the bathroom and/or in cases of medical emergency—video stream from the bathroom is a severe compromise of privacy, however an alarm for emergency cases does not compromise privacy, has very low probability of ever be triggered, and if triggered can save lives.

One of the privacy supporting embodiments for the above example is the complete computer vision system adjacent to the video acquisition camera, where all the acquired video remains within the local system, while only the high level information (alarm signal) can be transmitted outside of the system, while the raw acquired video never leaves the local system/device.

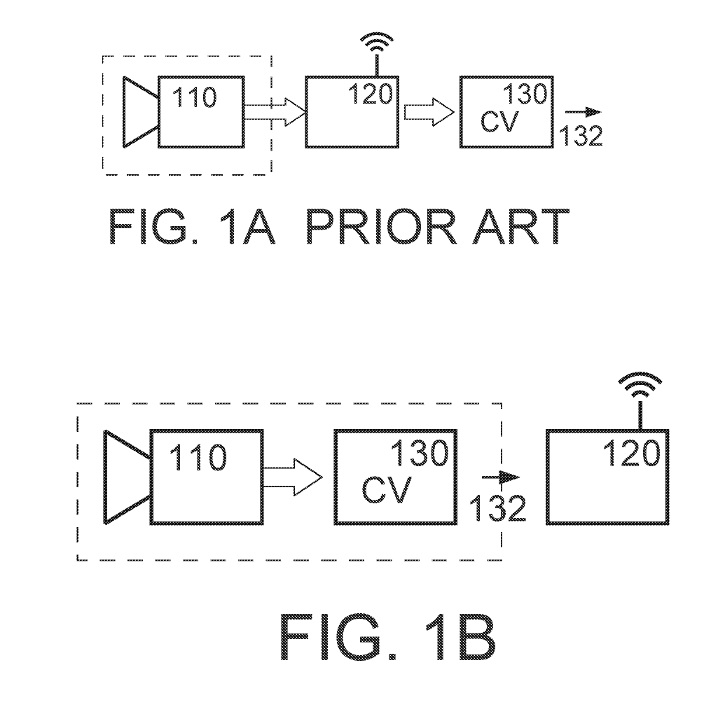

FIGS. 1A and 1B further illustrate the above example. 1A shows the block diagram of the prior art computer vision systems, where the camera 110 acquires a video stream of the scene and further relays the acquired video stream to interface block 120, from where the video may be further transmitted to a network, remote computer, storage or any other access. one may consider any information reaching block 120 as potentially compromised. 130 is the Computer Vision (CV) block, which processes the acquired video and extracts the required information, such as alarms in certain situations, and then transmits if for further use via 132.

FIG. 1B shows one of the privacy supporting embodiments, where the computer vision block 130 is adjacent to the camera 110. Computer vision block 130 analyzes the video stream, extracts the necessary information from it and transmits further only the extracted information via 132, while the video stream is discarded after being analyzed in CV block 130. Only the relevant information extracted by computer vision module reaches the interface block 120, and is further transmitted, while the video does not even reach the block 120, and therefore cannot be further transmitted, compromising privacy.

However not all computer vision systems are born equal. Consider a computer vision system for intrusion detection, installed in a private house. The output of the system transmits the images and the video of intruders in the private house, after they are detected. The video with intruders can be transmitted to an appropriate security authority. It is however the concern of the family, that videos and images of their every-day life and affairs are not being transmitted outside of the family house.

FIG. 1C illustrates an embodiment supporting user privacy for that scenario. 110 is the camera, acquiring the video; 115 is the processing module; 120 is the interface module and 130 is the computer vision module. One of the objectives of the processing module 115 is to modify/sanitize the video stream from the camera 110, removing or rendering innocuous privacy compromising content of the video. The privacy sterile information is relayed towards the interface module 120, and then to the computer vision processing module 130.

There are various specific embodiments of module 115. In some embodiments the familiar persons are detected, recognized, segmented out of the image and then processed by blurring, painting out or otherwise processed to erase the privacy compromising content. Said processing can be applied only in specific cases, which can depend on location, time, scene, situation, state of dress; the processing can be applied only to specific regions of the image or body parts, such as faces, naked skin or otherwise selected.

In other embodiments the operation of module 115 is organized as pre-processing before the computer vision algorithms in module 130. Examples of this pre-processing include feature-extraction for further machine learning algorithms, extraction of edges, motion flow, and other parameters and information further used in module 130. It may be only the extracted parameters which are relayed to the interface module 120, while the original video is discarded within 115.

The module 120 is a schematic illustration of many different embodiments. It is referred to as ‘interface module’, however that reference should not be treated as a limitation of interpretation. It schematically denotes a point within the system processing pipeline where all the information before it is considered as inaccessible from the outside world, while the information after it is considered as potentially accessible. The information can be relayed by various different ways, such as wired or wireless output of the video, e.g. via USB (universal serial bus), Wi-Fi, or other interfaces; recorded to the flash memory or other memory carriers, transmitted for processing within the same device or to remote computer.

FIG. 1D illustrates several aspects of the disclosed invention. Camera 110 acquires video of the scene and relays it towards an extraction/sanitization module 120 (hereinafter: “E/S module”), which extracts the information required for further video processing and/or sanitizes the video removing privacy infringing data and relays the extracted/sanitized information to the video processing in the processing module 140, and/or to cloud processing 150.

For example, a computer vision application may require face detection. One of the approaches to face detection is via calculating the response of a cascade of filters, and then comparing the responses to certain thresholds. In this case the information extraction phase will be an application of the relevant cascade of filters to the image, and the calculated coefficients of the responses to the applied filters will be the extracted information, transmitted for further processing. The locations on the image where the set of filters is applied can be defined at every pixel, or at every point of a sparse grid of locations spanned over the image, at certain regions of interest, or determined according to other modules of the computer vision application. At a later stage the set of extracted coefficients can be used to determine whether there is a face at the corresponding location, and to recognize the particular face.

The results of the processing in the processing module 140 and/or in the cloud 150, which may include the reports and information on detected pre-defined situations, are transmitted over the data bus 155 for further use in the system.

145 denotes the feedback from the vision system towards the camera, intended for task-specific tuning of the camera, e.g. automatic exposure, focusing, white balance and other parameters. Conventionally, cameras are designed and optimized to obtain the images/videos which are the most suited for viewing by human eyes. For the computer vision systems, however, the criteria of image quality is often different.

The data bus 115 relaying the video from camera 110 to the E/S module 120 supports the necessary bitrate to relay the video stream. There is no video stream relayed out of the camera module 130, but only the sanitized/extracted video information, relayed over the data bus 125. The bitrate of the sanitized/extracted information over bus 125 may therefore be a significantly lower bitrate than the video bitrate over bus 115.

In one of the embodiments of present invention, the characteristic of the maximum bitrate supported by the bus 125 being significantly lower than the bitrate of the video of satisfactory quality, prevents transmission of the video from the camera module 130. The bitrate from several tens of bytes to several kilobytes per frame, or from hundreds of bytes per second to tens of kilobytes per second can be sufficient for many applications. For example, for a face recognition application, not the image of the face, but only an extracted descriptor or signature may be transmitted. The size of the signature can be from several tens of bytes to several kilobytes. The descriptor can be a feature vector, extracted as a set of coefficients after application of corresponding filters.

It is the video processing firmware running in the E/S module 120 that sanitizes/extracts/derives the desired information from the video stream. The E/S module 120 may comprise CPU, GPU, DSP, FPGA and other signal, image, video processing circuitry. Bus 165 denotes the bus for programming, configuring and updating firmware or hardware architecture.

In some of the embodiments of present invention, bus 165 is made to be ‘burnable’ after programming and/or configuring of the E/S module 120. Thus, the configuring is made final by terminating the further ability of reprogramming and reconfiguring. It can be done via burnable fuses, OTP (one-time-programming) elements, or other methods known in the art.

175 denotes an optional temporary video output, which can be used at initial stages for adjustment, tuning and training of the system. Subsequently this video output 175 can be permanently disabled by a burn-out switch, or deactivated by other means known in the art, permanently or revocably. In the case of revocable deactivation of video output, it can be done via local switch on the camera, wherein pressing of the button or turning the switch or removing the key disables the video output ability of the camera.

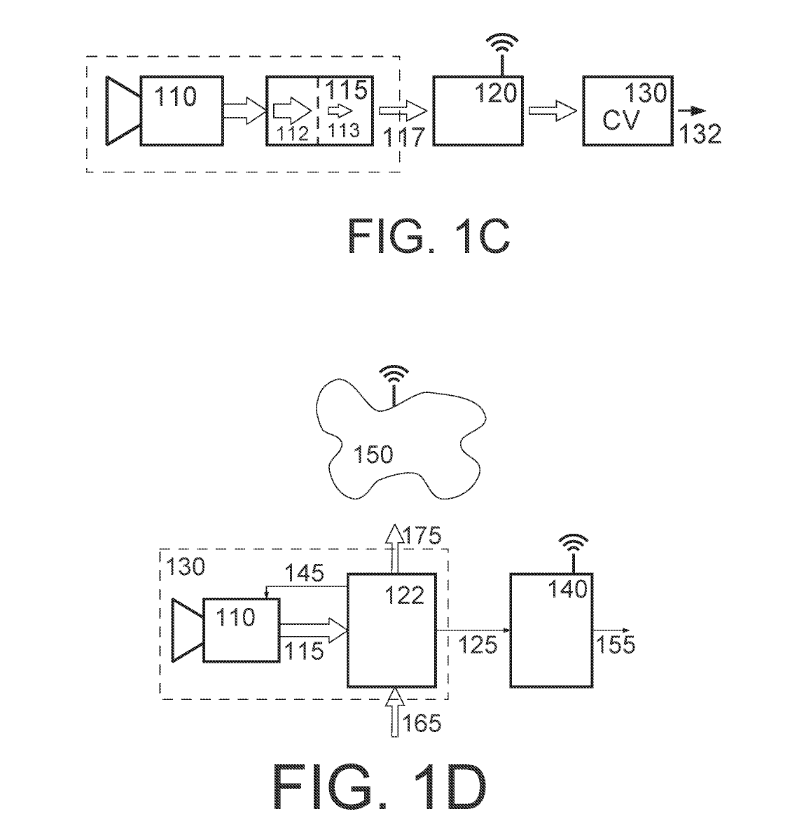

FIG. 2 schematically illustrates several aspects of some embodiments of the E/S module 120. 240 denotes the input interface that receives the video stream for the processing. The received video stream can be processed on CPU (235), GPU (245), dedicated DSP (225), FPGA or other programmable architecture circuits (240); or other processing circuits, as known in the art.

It is the firmware executing on the blocks 225, 235, 240, 245 and programmable hardware architecture in the blocks 240, 230, which defines which information is sanitized/extracted/derived from the video and relayed outside of the system. Therefore, for proper maintenance of the privacy safeguards, it is important to properly control the procedure of updating the firmware and FPGA.

Configuration controller 210 denotes the hardware responsible for the update of the firmware. It can update the firmware and/or reprogram the FPGA. The firmware can be flashed into the Flash memory 220, OTP memory 230, or other retainable memory for loading into RAM and execution during the system operation. The sanitized/extracted/derived data is relayed for further use via the data output interface 250.

Various security mechanisms can be implemented to protect the firmware in the system from unauthorized modification. They include firmware encryption, password protected authorization for firmware updates, private and public key encryption and authorization, and other methods known in the art of information and computer security.

One time programmable (OTP) memory, and OTP configuration switches, as well as burnable fuses may be applied as the mechanism for finalization of firmware updates/FPGA programming.

Now let us consider in more details some of the specific applications of the disclosed system, and embodiments for their enablement.

As an example of the application, and some of the embodiments, consider a surveillance system installed in multiple locations of a private house. The purpose of the system's monitoring is automatic detection and reporting of emergency situations, such as fire, medical emergency, intrusion and violence. The system's reaction to an emergency situation may be to report over the telephone or computer network the detected situation including descriptive data sanitized for the protection of privacy.

Some embodiments of the invention are complete computer vision systems programmed and trained to detect emergency situations from video streams acquired by one or more cameras, and optionally, data obtained from other sensors.

Consider the task of fire detection from the video stream. Fire is characterized by smoke, flames, lighting changes and resulting changes of the appearance of the environment and objects. Both smoke and change of appearance of burning objects can be detected by background subtraction, and analysis of the difference between the current frames from the video stream, and known background, which was learned by accumulating and averaging of the video over an extended period of time.

Therefore, one of the embodiments of the system for fire detection will comprise a feature extraction stage, where features are based on the color spectral histograms, and on the spectral analysis in the time domain (time domain Fourier transformation). The extracted features are transmitted for further analysis. Further analysis includes application of the extracted features to the trained detector, which in turn separates between the video sequences with and without fire. The detector is pre-trained on the ground truth sequences, marked by human observers, which include many cases of fire and absence of fire. Exactly the same features are extracted from the ground truth data for training of the detector.

Flames and smoke can also be dynamic processes, with characteristic color signatures. This dynamic nature may be acquired by calculating the time derivative of the video, which in turn is a normalized difference between the adjacent video frames. Flames and smoke are differentiated from other dynamic processes, such as motion of objects and subjects by analysis of their colors, texture, and dynamics.

In other words, many sample videos of fire situations may be observed and analyzed and the characteristic features of the flames effect on the image data determined. These characteristic features may then be encoded into algorithms that evaluate such characteristics, and compare them to certain thresholds. By adjusting the thresholds the algorithm can improve the differentiation until a satisfying performance is achieved. We will refer to this and similar approaches as the algorithmic approach.

Some of the embodiments for algorithmic approach are systems where the computer algorithms are executed on the processing hardware in the vicinity of the video camera, and only the results of the algorithms are further transmitted. For example, a fire may be represented by the code ‘1’, violence ‘2’, intrusion ‘3’, medical emergency ‘4’. These codes may be then transmitted on by the system.

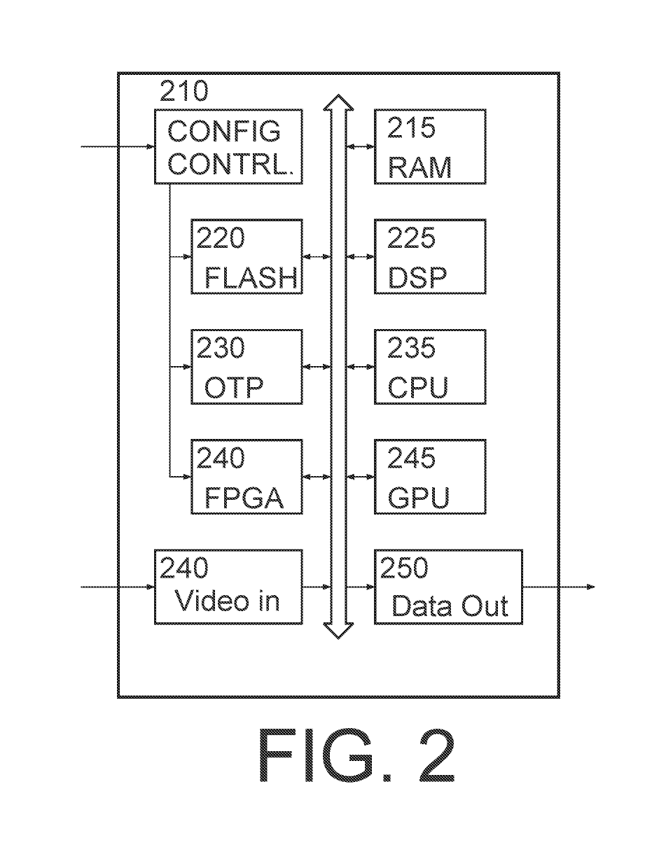

FIG. 3 schematically illustrates the embedded approach to privacy supporting computer vision system. 300 denotes the complete computer vision system, which comprises a video camera 310, acquiring the video and transmitting it over the bus 315 to the processing module 320. The processing module 320 can execute various computer vision algorithms, such as object detection and tracking, scene analysis, machine learning and deep learning algorithms, and other algorithms.

Other optional sensors and components of the system are not illustrated for the sake of clarity and brevity.

An alternative approach will be referred to as the machine learning approach, when the programmer by observing the differences between the phenomena to be detected (such as smoke or flames) and between other images or videos, without smoke or flames, looks for ‘features’ which will help to distinguish between videos with and without flames. Multiple different features extracted from the image form a so called feature vector, which is a set of numbers, which can be considered as a point, or a vector in the multi-dimensional feature space.

The feature extractor is the program that runs on the input data (set of frames or video sequences in this case) and extracts the features from that input data.

Various different features are known in the art of computer vision. For example Histograms of Gradients (HOG), SIFT, Wavelets, DCT, to list a few. Many other features are known in the art, and their exhaustive listing is impossible. Moreover, custom and new features can be designed for each specific task.

After defining the set of features, and implementing (encoding) the feature extractor, the features from the videos with the phenomena (e.g. flames), called positive examples and without the phenomena (set of videos without flames), called negative examples are extracted. The set of feature vectors from positive and negative examples is used to train the classifier.

At the detection phase, the input frames are scanned with the sliding window, which selects the region of interest. The features are then extracted and quantified into feature vectors from the region of interest, and transmitted towards the classifier, which, in turn, on the basis of the input feature vector, calculates whether the region of interest belongs to the given class.

The sliding window can run along the image, at different positions and at different scales of the window, covering a range of possible positions and possible locations of the objects.

Examples of the objects to be detected may be faces, people, animals, objects, cars, buildings. More advanced examples of detection may be the detection of certain scenarios/situations, such as fire, intrusion, violence, medical emergency, etc.

More advanced video analysis may include hierarchic analyses, when detected objects are tracked from frame to frame, their motion and mutual interaction analyzed, the secondary features, based on scene dynamics, object motion and interaction are extracted and used for further training, scene and situation analysis, detection and classification.

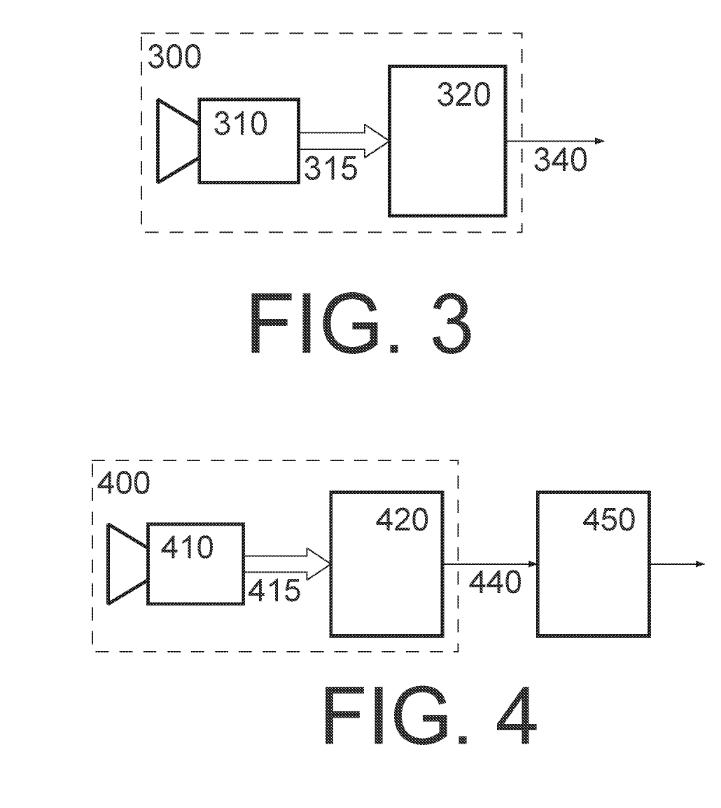

FIG. 4 schematically illustrates a block diagram of machine vision approach to privacy supporting computer vision system. 410 is the video camera. 420 is the block denoting feature extraction and other required processing. The extracted features along with optional other information that are transmitted over the bus 440 for further recognition and processing. Privacy is protected by the fact that the acquired video is not transmitted over the bus 440, and discarded after processing block 420.

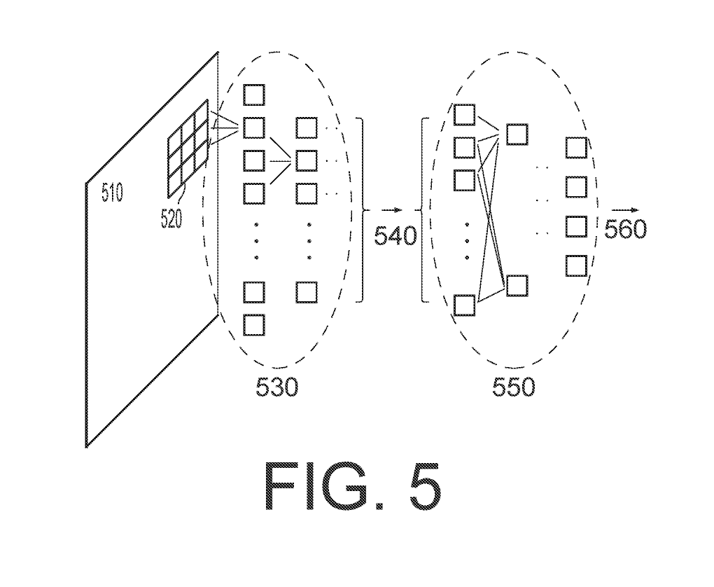

FIG. 5 schematically illustrates some embodiments of the invention, comprising neural networks. Deep learning (deep structured learning, hierarchical learning or deep machine learning) is a branch of machine learning based on a set of algorithms that attempt to model high-level abstractions in data by using multiple processing layers, with complex structures or otherwise, composed of multiple non-linear transformations.

Various deep learning architectures such as deep neural networks, convolutional deep neural networks, deep belief networks and recurrent neural networks have been applied to fields like computer vision, automatic speech recognition, natural language processing, audio recognition and bioinformatics where they have been shown to produce state-of-the-art results on various tasks.

The internal representation of the input image in the middle layers of neural network does not resemble the input image, and in most practical cases does not contain the information necessary to reconstruct the original input image, and therefore naturally protects the privacy.

This the embodiment is based on division of the neural network into at least two parts, where the first part, consisting of one or more processing layers is adjacent to the video camera, the output of this part of the neural network is transmitted towards the second part of the of one or more layers for further processing.

This approach has not only the benefit of protected privacy, but also additional advantages by saving the communication bandwidth due to compression in the initial layers, and saving the computation power due to transferring the computational burden of final layers to the remote computing.

510 denotes an input image array, where 520 denotes several adjacent pixels corresponding to particular small region of that image array.

It can be a raw output frame of the video camera, or the image after some processing, such as region selection, geometric, value transformations, operations of tracking and selections and other processing as known in the art of image, video processing and computer vision. 520 illustrates a few pixels from selected part of the image. 530 and 550 together form a multi-layer neural network.

One of the novel inventions disclosed here is the division of the neural network into multiple parts, e.g. 530 and 540, with data transmitted from 530 to 550 over one or more data paths 540.

It is important to note, that while the input data feeding into the neural network can be a raw image or video data, within the first layers of the neural network it is compressed and processed information.

Moreover, if the neural network was trained for solving a particular problem, then the information extracted by its layers is particular relevant information, while irrelevant and potentially privacy-violating information is filtered out.

Data paths 540 can be wired or wireless, with the destination 550. It should be understood that what is described herein as 2 data paths/neural-network-parts may be 5 data paths/neural-network-parts, 10 data paths/neural-network-parts, or 1000 data paths/neural-network-parts. Various architectures of neural networks and partitions into parts 530 and 550 can be used. In the general case, parts 530 and 550 can be considered as the generic computer vision processing, divided into first part 530 and the second part 550, where 540 denotes the information transmitted after processing in 530 for the further processing in 550.

One of the benefits of this division is support of privacy by isolation of segments of the video part from the external world. The frames of the video are input to the processing part 530, however the output 540 is the specific information extracted by the network, related to detection of certain events, according to the network training.

Another benefit of this division is the enablement of facilitation of remote video processing. For many computer vision applications, the limited and relatively weak processing power within the device limits the amount and quality of applications, while large bandwidth of video stream limits the ability to send the video stream for remote processing

What is claimed is:

1. A video surveillance system comprising:
a surveillance unit comprising:
a video sensor configured to capture a video stream of an area;
a video stream pre-processor, comprising processing circuitry configured to extract from the video stream a sanitized data stream, by modifying the video stream to remove or modify image data from the video stream private to one or more individuals, wherein the sanitized video stream contains parameters of the video stream sufficient to identify one or more pre-defined event types occurring within the area and captured by the video sensor; and
first communication circuitry adapted to transmit the sanitized data stream;
and
a monitoring unit comprising:
second communication circuitry adapted to receive the sanitized data stream; and
sanitized video processing circuitry configured to identify parameters within the sanitized video stream indicating the occurrence of one of the one or more pre-defined event types.

2. The video surveillance system according to claim 1, wherein the one or more event types includes a fire type event and the sanitized video stream contains color parameters of the video stream sufficient to identify a fire type event.

3. The video surveillance system according to claim 1, wherein the surveillance unit is adapted to transmit the sanitized video stream in parts.

4. The video surveillance system according to claim 1, wherein said first communication circuitry is characterized by a maximum bitrate lower than a minimum bitrate required for video stream transfer.

5. The video surveillance system according to claim 1, wherein removing or modifying image data from the video stream private to one or more individuals includes identifying image data associated with body parts of individuals.

6. The video surveillance system according to claim 1, wherein removing or modifying image data from the video stream private to one or more individuals includes removing or modifying image data associated with one or more sensitive regions.

7. The video surveillance system according to claim 1, wherein removing or modifying image data from the video stream private to one or more individuals includes identifying image data associated with a private event type.

8. A video surveillance apparatus comprising:
a video sensor configured to capture a video stream of an area;
a video stream pre-processor, comprising processing circuitry configured to extract from the video stream a sanitized data stream, by modifying the video stream to remove or modify image data from the video stream private to one or more individuals, wherein the sanitized video stream contains parameters of the video stream sufficient to identify one or more pre-defined event types occurring within the area and captured by the video sensor; and
first communication circuitry adapted to transmit the sanitized data stream;

9. The video surveillance apparatus according to claim 8, wherein the one or more event types includes a fire type event and the sanitized video stream contains color parameters of the video stream sufficient to identify a fire type event.

10. The video surveillance apparatus according to claim 8, wherein the surveillance unit is adapted to transmit the sanitized video stream in parts.

11. The video surveillance apparatus according to claim 8, wherein said first communication circuitry is characterized by a maximum bitrate lower than a minimum bitrate required for video stream transfer.

12. The video surveillance apparatus according to claim 8, wherein removing or modifying image data from the video stream private to one or more individuals includes identifying image data associated with body parts of individuals.

13. The video surveillance apparatus according to claim 8, wherein removing or modifying image data from the video stream private to one or more individuals includes removing or modifying image data associated with one or more sensitive regions.

14. The video surveillance apparatus according to claim 8, wherein removing or modifying image data from the video stream private to one or more individuals includes identifying image data associated with a private event type.

15. A video surveillance apparatus comprising:
a video sensor residing within a housing and configured to capture a video stream of an area;
a video stream processor, residing within the housing and comprising processing circuitry configured to identify a pre-defined event type occurring within the area and captured by the video sensor; and
first communication circuitry, residing within the housing and adapted to transmit a signal indicative of the occurrence of the event type, upon an identification by the video stream processor of a pre-defined event type occurrence within the area;
wherein said apparatus is configured to discard the video stream after processing by said video stream processor.

16. The video surveillance apparatus according to claim 15, wherein said first communication circuitry is characterized by a maximum bitrate lower than a minimum bitrate required for video stream transfer.

17. The video surveillance apparatus according to claim 15, wherein the pre-defined event type is a fire.

18. The video surveillance apparatus according to claim 15, wherein the pre-defined event type is an event of violence.

19. The video surveillance apparatus according to claim 15, wherein the pre-defined event type is an intrusion into the area.

20. The video surveillance apparatus according to claim 15, wherein the pre-defined event type is a medical emergency.
